(19) United States
(12) Patent Application Publication
(10) Pub. No.: US 2007/0267056 A1
(43) Pub. Date: Nov. 22, 2007

(54) SIMULATED SOLAR LIGHT IRRADIATION APPARATUS

(76) Inventor: Yoshihiro HISHIKAWA, Abiko-shi (JP)

Correspondence Address: OSTROLENK FABER GERB & SOFFEN, 1180 AVENUE OF THE AMERICAS, NEW YORK, NY, 100368403, US

(21) Appl. No.: 11/748,141

(22) Filed: May 14, 2007

(30) Foreign Application Priority Data
May 16, 2006 (JP) P2006-137096

(51) Int. Cl. H02N 6/00

(52) U.S. Cl. 136/246

(57) ABSTRACT

A simulated solar light irradiation apparatus is provided which irradiates light onto a test piece 6, in which a plurality of filters 4 for improvement in the uniformity of light on a surface of the test piece 6 are arranged, between a light emission portion 2 and the test piece 6, on a plane substantially vertical to an optical axis.

### BACKGROUND OF THE INVENTION

1. Field of the Invention

The present invention relates to a simulated solar light irradiation apparatus for use as a light source in estimation of performance of a solar cell or in a light environmental test apparatus or the like. Priority is claimed on Japanese Patent Application No. 2006-137096, filed on May 16, 2006, the content of which is incorporated herein by reference.

2. Description of Related Art

In solar simulators, optical systems having a curved surface such as integrator optical systems (fly eye lens optical systems) have been conventionally used in order to irradiate light with uniformity within several percentages on the entire surface of a test piece. Here, a solar simulator is an apparatus for irradiating light that simulates the intensity and spectrum of sunlight onto a test piece such as a solar cell. The required performance of a solar simulator is described in, for example, JIS (Japanese Industrial Standards) C8912. The optical configuration thereof is described in, for example, Non-Patent Document 1 or Non-Patent Document 2.

FIG. 6A shows an example of an optical system of a solar simulator.

In the figure, an elliptic mirror is for introducing light from a xenon lamp into an integrator lens. The integrator lens is an optical element composed of a plurality of paired lenses, each of the pair facing each other. As for the material thereof, optical glass such as BK7 or silica glass is used. The light having entered the integrator lens from the elliptic lens is irradiated onto the entire surface of the test piece by respective paired lenses of the integrator lens. Thus, it is possible to uniform the non-uniformity of the incident light for irradiation onto the test piece. Note that an output lens may be used to obtain a parallel irradiation light.

FIG. 6B shows another example of an optical system of a solar simulator based on a type of optical design which is not using a lens or the like.

### Non-Patent Document 1: Light Edge, an information publication on optical technology, Ushio Inc., Vol. 23, 2001

### Non-Patent Document 2: Light Edge, an information publication on optical technology, Ushio Inc., Vol. 15, 1998

However, the optical system of the solar simulator, which is shown in FIG. 6A, uses curved-surface optical components such as an elliptic mirror or a lens. Therefore, precise curved-surface optical components are required to obtain irradiation distribution with favorable uniformity, for example, within ±2% on the test piece surface. However, these curved-surface optical components have had a problem that they are difficult to manufacture and expensive. Furthermore, relative positions and angles of the lamp, the elliptic mirror, and the lens have been required to be individually adjusted, which leads to a problem of cumbersome adjustments of the optical system including the lamp and the elliptic mirror or the like.

The more vertical the entry and exit of light into/out of the integrator lens is, the more likely a desired performance is obtained. In this case, however, the distance between the light source and the integrator lens and the distance between the integrator lens and the test piece need to be long. As a result, there has been a problem that the apparatus is made larger to obtain irradiation with favorable uniformity on the test piece surface.

In the optical system of a solar simulator shown in FIG. 6B, no curved-surface optical system is used. However, there has been a problem that a light source with high irradiance is required, since of the light from the light source, only light directly irradiated in the direction of the test piece is utilized.

### SUMMARY OF THE INVENTION

In view of the above-mentioned circumstances, an object of the present invention is to provide a simulated solar light irradiation apparatus with improved uniformity of light on a test piece surface by arranging a plurality of filters, between a light emission portion and a test piece, on a plane substantially vertical to an optical axis.

A first aspect of the present invention is a simulated solar light irradiation apparatus that irradiates light onto a test piece, in which a plurality of filters for improvement in the uniformity of light on a surface of the test piece is arranged, between a light emission portion and the test piece, on a plane substantially vertical to an optical axis.

A second aspect of the present invention is the simulated solar light irradiation apparatus according to the first aspect, in which the plurality of the filters are made of one or more types of filters with different spectral transmittance of light.

A third aspect of the present invention is the simulated solar light irradiation apparatus according to the first aspect, in which the plurality of the filters have sizes and transmittances established such that a region on the test piece surface with relatively higher light irradiance is reduced in light irradiance for improvement in the uniformity of the test piece surface.

A fourth aspect of the present invention is the simulated solar light irradiation apparatus according to the first aspect, in which letting R=(the area on which the filters have the effect of light reduction)/(the area of the filters), 10>R>0, or more preferably 4>R>0.

In conventional simulated solar light irradiation apparatus, to achieve light irradiance distribution with favorable uniformity on a test piece surface, the positions of the light source, mirror, lens or the like are required to be precisely adjusted. Moreover, uniformity of light irradiance is restricted by the precisions of these optical components and the apparatus size. Thus, the uniformity is often restricted to about ±2% to ±5%. However, according to the simulated solar light irradiation apparatus of the present invention, light uniformity is adjusted by the filters disposed between the light emission portion and the test piece surface. Therefore, exactness is not required for the manufacturing precision and position adjustment of the optical components, thereby achieving a uniformity of about ±1% to ±2%. Furthermore, in the prior art, it has been required to secure a long distance between the light emission portion and the test piece surface in order to obtain light irradiance distribution with favorable uniformity. However, according to the simulated solar light irradiation apparatus of the present invention, it is possible to improve uniformity without such restrictions.

Furthermore, in the prior art, uniformity of light irradiance distribution on the test piece surface has sometimes varied depending on the wavelength of light. However, in the present invention, it is possible to easily obtain light irradiance distribution with favorable uniformity by use of filters with different spectral transmittance.

### BRIEF DESCRIPTION OF THE DRAWINGS

FIG. 1 is a perspective view showing a configuration of a simulated light irradiation apparatus according to a first embodiment of the invention.

FIG. 2 is a front cross-sectional view of the simulated light irradiation apparatus shown in FIG. 1.

FIG. 3 is a perspective view showing a configuration of a simulated light irradiation apparatus according to a second embodiment of the invention.

FIG. 4 is a side view showing a configuration of a simulated light irradiation apparatus according to a third embodiment of the invention.

FIG. 5 is an enlarged front view showing the filter portion 4 shown in FIG. 4.

FIG. 6A is a drawing showing an example of an optical system of a solar simulator according to the prior art.

FIG. 6B is a drawing showing an example of an optical system of a solar simulator according to the prior art.

### DETAILED DESCRIPTION OF THE INVENTION

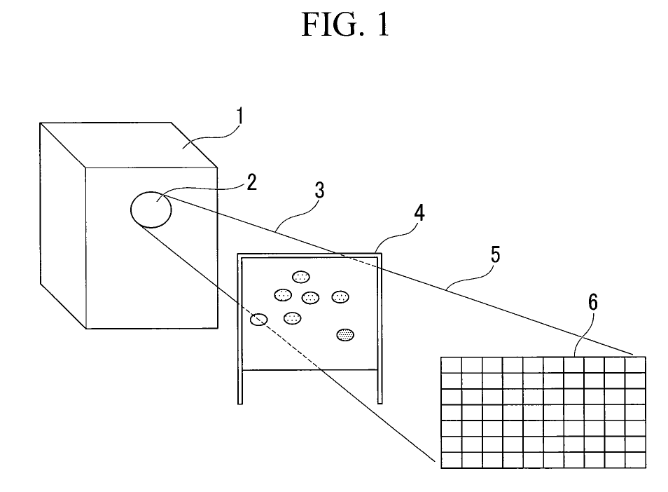

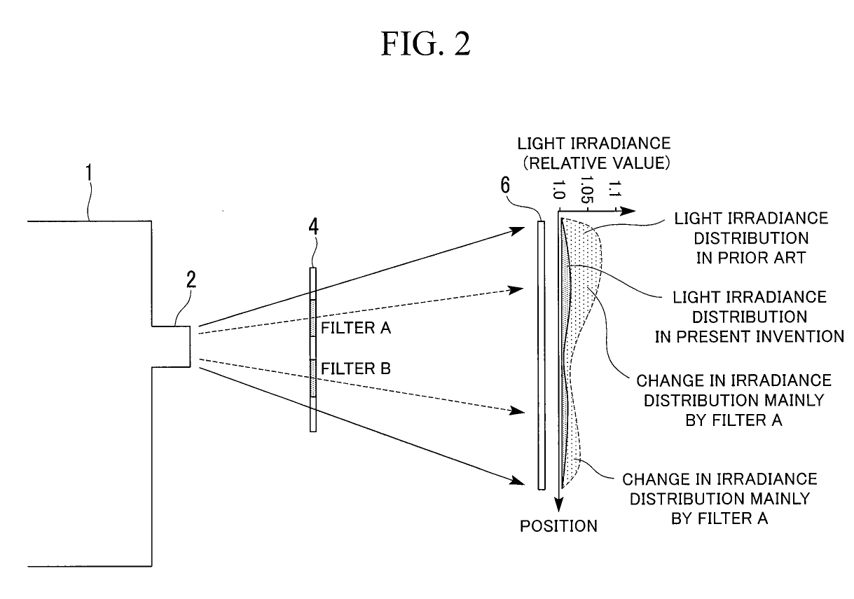

A first embodiment of the present invention will be described with reference to FIG. 1 and FIG. 2.

FIG. 1 is a perspective view showing a configuration of a simulated light irradiation apparatus according to this embodiment of the invention. FIG. 2 is a front cross-sectional view of the simulated light irradiation apparatus shown in FIG. 1.

This simulated solar light irradiation apparatus is a solar simulator that irradiates simulated solar light onto a solar cell module as a test piece 6. For a light source portion 1, a xenon lamp is used. Light emitted from a light emission portion 2 is irradiated onto the test piece 6. Between the light source portion 1 and the test piece 6, a plurality of filters A and B in a filter portion 4, which is supported by a frame, is provided. The filters A and B adjust the distribution of light emitted from the light emission portion 2 to improve light uniformity on a surface of the test piece 6. When the filter portion 4 is not provided, light irradiance distribution of about ±3% is presented as indicated by the broken line shown in FIG. 2. On the other hand, when the filter portion 4 as in the present invention is provided, a region surrounded by the broken line and the solid line is reduced in light by the filter portion 4, improving uniformity such that light irradiance distribution of about ±1.0% is obtained as indicated by the solid line.

In FIGS. 1 and 2, the test piece 6 surface measures about 2 m×2 m; the distance between the light source portion 1 and the test piece 6 surface is about 5 m; the distance between the light source portion 1 and the filter portion 4 is about 2 m; the area of the filter portion 4 in which the filters A and B are disposed is within a circle with a diameter of 100 cm; and the light emission portion 2 has a circular shape with a diameter of 50 cm. In FIG. 2, the filters A and B in the filter portion 4 are arranged at positions that would reduce irradiance of a portion with higher irradiance on the test piece 6 surface when the filters A and B are not provided. Specifically, for the filters A and B, a mesh (metal gauze) made of black coated metal wires is used. The size thereof is about 30 cm square. Transmittance of the mesh is 95%. Other than this, glass or the like may be used for the filters A and B. Alternatively, colored glass whose transmittance varies depending on the wavelength may be used for the filters A and B. As for the light source portion 1, another type, for example, a plurality of xenon lamps or a metal halide lamp may be used.

It is preferable that the filters such as the filters A and B or the like be disposed in the filter portion 4 at positions that allow easy control over uniformity of irradiance on the test piece 6 surface. What matters is the relationship between an area of the filters and an area on which the filters have the effect of light reduction. If the ratio R=(the area on which the filters have the effect of light reduction)/(the area of the filters) is too high, light reduction by the filters extends over a wide range on the light irradiated surface. As a result, it is impossible to effectively control irradiance distribution on the light irradiated surface. Therefore, as for the value of the above-mentioned R, 10 or less and 0 or more is effective, and especially 4 or less and 0 or more is more effective. Here, in FIG. 1, reference numeral 3 denotes an irradiated light before passing filter and reference numeral 5 denotes irradiated light after passing filter.

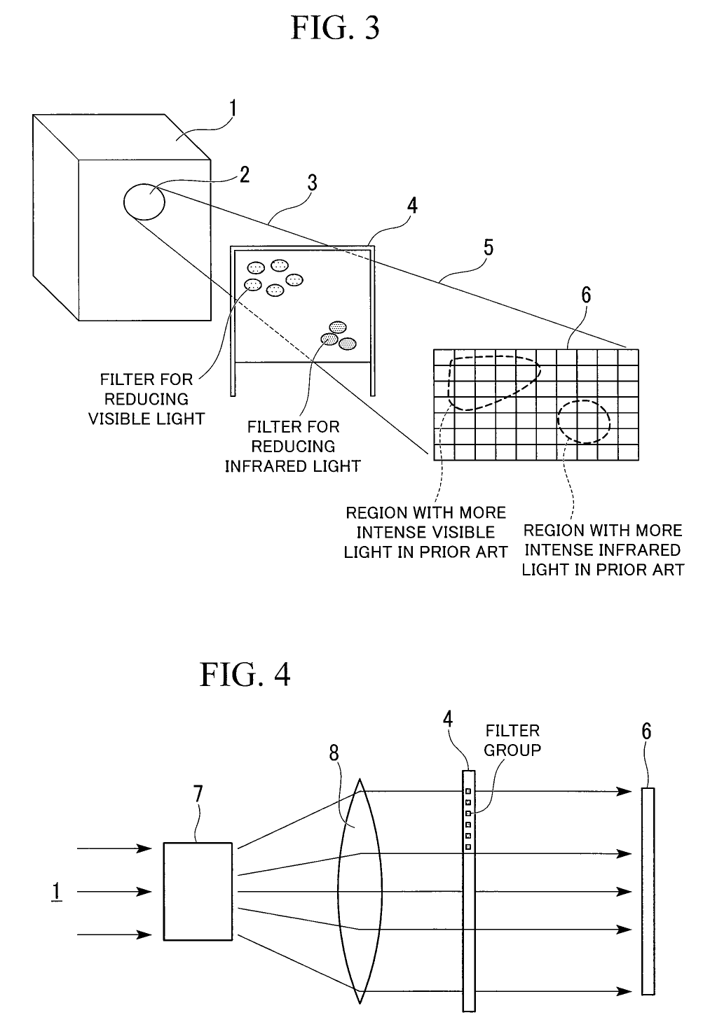

Next, a second embodiment of the present invention will be described with reference to FIG. 3.

FIG. 3 is a perspective view showing a configuration of a simulated light irradiation apparatus according to this embodiment of the invention.

Conventionally, non-uniformity of irradiance on the test piece 6 surface sometimes varies depending on the wavelength of light. This is because a region with more intense visible light and a region with more intense infrared light are present on the test piece 6 surface as shown in FIG. 3, in the case where one or more types of lamps, for example, a xenon lamp and a halogen lamp, are used for the light source portion 1, where a light source with a function capable of varying the spectral irradiance of the light source with a multi-layered film filter or the like or where chromatic aberration of the optical system exists. In this case, according to the simulated solar irradiation apparatus of the present invention, one or more types of filters are disposed in the filter portion 4 at different positions to mainly reduce visible light in the region with more intense visible light and to mainly reduce infrared light in the region with more intense infrared light on the test piece 6 surface. The filters for reducing visible light are disposed at positions that allow reduction in intensity of the irradiated visible light in a region with more intensity. The filters for reducing infrared light are disposed at positions that allow reduction in intensity of the irradiated infrared light in a region with more intensity. When these filters were not employed, the uniformity of light on the test piece 6 surface was ±5% for both visible light and infrared light. Thus, the region with more intense visible light and the region with more intense infrared light were different from each other. However, according to the simulated solar light irradiation apparatus of the present invention, it has become possible to secure irradiance with a uniformity of ±2% for both visible light and infrared light.

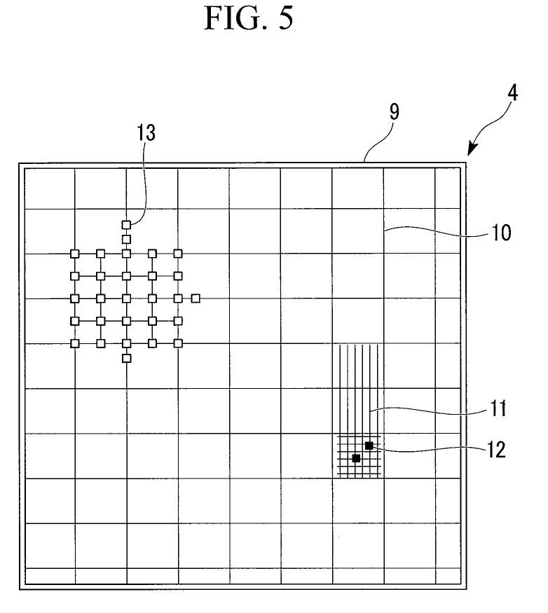

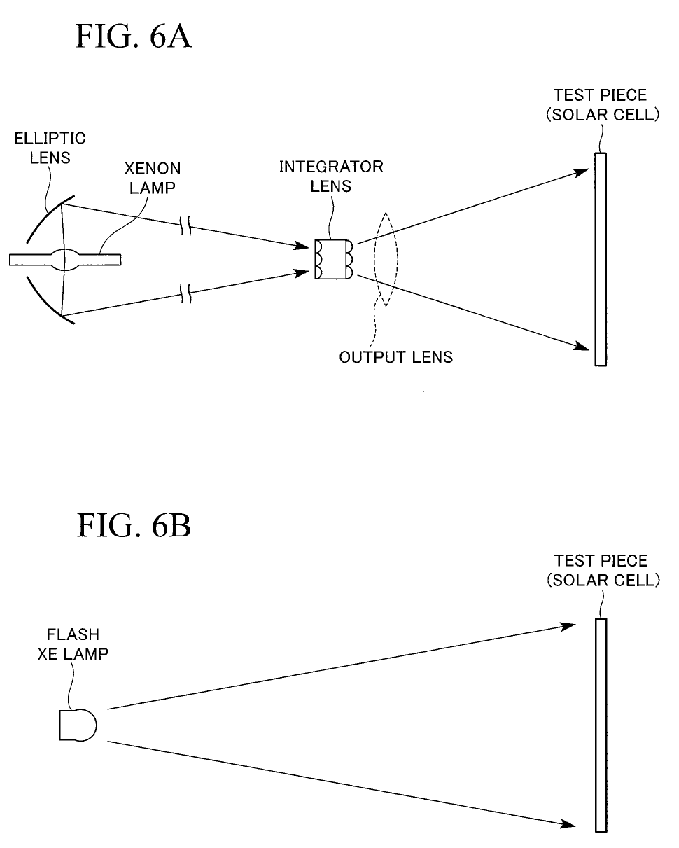

Next, a third embodiment of the present invention will be described with reference to FIG. 4 and FIG. 5.

FIG. 4 is a side view showing a configuration of a simulated light irradiation apparatus according to this embodiment of the invention. FIG. 5 is an enlarged front view showing the filter portion 4 shown in FIG. 4.

In FIG. 4, an integrator lens 7 and an output lens 8 correspond to the configuration of the light emission portion 2 shown in FIG. 1 or the like. Substantially parallel light is irradiated from the output lens 8 toward the test piece 6 via the filter portion 4.

In the filter portion 4, as shown in FIG. 5, grid wires 10 made of metal wires or resin wires with a diameter of 0.1 mm are spaced 5 cm apart in the filter frame 9. The filters are fixed onto the grid wires 10. The positions and wire thickness of the grid wires 10 are selected so as not to adversely affect light uniformity on the test piece 6 surface. As for the types of the filters, mesh filters 11 made of metal wires or resin wires, light shielding filters 12 made of metal or the like, colored glass filters 13 or the like are used. By use of these filters, uniformity in the irradiated area of 30 cm square has improved from ±2% to ±1% or less. Note that a plate made of glass or resin may be used for disposing the filters.

What is claimed is:

1. A simulated solar light irradiation apparatus that irradiates light onto a test piece, wherein a plurality of filters for improvement in uniformity of light on a surface of the test piece are arranged, between a light emission portion and the test piece, on a plane substantially vertical to an optical axis.

2. The simulated solar light irradiation apparatus according to claim 1, wherein the plurality of filters are made of one or more types of filters with different spectral transmittance of light.

3. The simulated solar light irradiation apparatus according to claim 1, wherein the plurality of filters have sizes and transmittances established such that a region on the test piece surface with relatively higher light irradiance is reduced in light irradiance for improvement in the uniformity of light irradiated on the test piece surface.

4. The simulated solar light irradiation apparatus according to claim 1, wherein R=(an area on which the filters have effect of light reduction)/(an area of the filters), 10>R>0, more preferably 4>R>0.
